(19) United States
(12) Patent Application Publication
(10) Pub. No.: US 2012/0262146 A1
(43) Pub. Date: Oct. 18, 2012

(54) REFERENCE-VOLTAGE GENERATION CIRCUIT

(75) Inventors: Ayako MORITA, Osaka (JP); Kaori NISHIKAWA, Osaka (JP); Hirokuni FUJIYAMA, Hyogo (JP)

(73) Assignee: PANASONIC CORPORATION, Osaka (JP)

(21) Appl. No.: 13/365,816

(22) Filed: Feb. 3, 2012

Related U.S. Application Data
(63) Continuation of application No. PCT/JP2010/000335, filed on Jan. 21, 2010.

(30) Foreign Application Priority Data
Aug. 6, 2009 (JP) 2009-183541

(51) Int. Cl. G05F 3/02

(52) U.S. Cl. 323/313

(57) ABSTRACT

In a reference-voltage generation circuit using a diode, its temperature characteristics can be freely controlled. A regulating current supply section supplies a regulating current for regulating a diode current to an anode of one of a first or second diode. The regulating current supply section can change a magnitude of the regulating current, and can generate a current proportionate to a diode current of the other diode as the regulating current.

### CROSS-REFERENCE TO RELATED APPLICATION

This is a continuation of PCT International Application PCT/JP2010/000335 filed on Jan. 21, 2010, which claims priority to Japanese Patent Application No. 2009-183541 filed on Aug. 6, 2009. The disclosures of these applications including the specifications, the drawings, and the claims are hereby incorporated by reference in their entirety.

### BACKGROUND

The present disclosure relates to reference-voltage generation circuits formed in semiconductor devices, and more particularly to techniques enabling control of temperature characteristics of reference-voltage generation circuits.

A reference-voltage generation circuit is needed as a reference-voltage supply source of an analog circuit mounted in a semiconductor integrated circuit. FIG. 7 is a circuit diagram illustrating a general configuration of a conventional reference-voltage generation circuit. The reference-voltage generation circuit shown in FIG. 7 includes diodes D1 and D2 having different current densities, resistive elements R1, R2, and R3, a PMOS transistor MP1, and an operational amplifier (operational amplifier circuit) OP. Forward voltages Vd1 and Vd2 of the diodes D1 and D2 have negative temperature coefficients. On the other hand, the difference between the forward voltages of the diodes D1 and D2 has a positive temperature coefficient. Then, a forward voltage difference ΔV (Vd1−Vd2) is added to the forward voltage Vd1 of the diode D1, thereby eliminating temperature dependency of an output voltage Vo, and outputting, e.g., a voltage of about 1.25 V.

This respect will be described using numerical expressions. First, a general current equation of a diode is as follows.

Vd=Vτ×Ln (Id/Is)

Note that Vτ=κT/q, where

κ is Boltzmann's constant,

q is a charge amount of electrons,

T is an absolute temperature,

Id is a current flowing to the diode, and

Is is a saturated current of the diode.

From the configuration of FIG. 7 and the above current equation of the diode, the following expressions [1]-[5] are obtained.

Vd1=Vτ×Ln (Id1/Is) [1]

Vd2=Vτ×Ln (Id2/Is) [2]

Ir3=(Vo−Vd1)/R3 [3]

Ir3=(Vd1−Vd2)/R2 [4]

Id1=(Vo−Vd1)/R1 [5]

Therefore, the output voltage Vo of the reference-voltage generation circuit is as follows.

Vo=Vd1+(R3/R2)×Vτ×Ln(Id1/Id2) (11)

In the expression (11), the first term has a negative temperature coefficient, and the second term has a positive temperature coefficient from the expression ([1]-[2]). Therefore, ideally, the temperature dependency is eliminated and the voltage of about 1.25 V is output.

However, indeed, due to diffusion variation of devices etc., a temperature gradient also varies. Thus, for example, as shown in FIG. 8, a reference-voltage generation circuit as little dependent as possible on a temperature is suggested (see, for example, Japanese Patent Publication No. JP62-079515A (1987)).

In the configuration of FIG. 8, bipolar transistors T1 and T2 include collectors commonly coupled to a terminal VDD of a supply voltage source, and bases commonly coupled to a terminal GND of reference potential. An emitter of the transistor T1 is coupled to a drain of a transistor M1 via a resistor R1. An emitter of the transistor T2 is coupled to a drain of the transistor M2 via serial resistors R3 and R2. Sources of the transistors M1 and M2, which are current sources, are coupled to a terminal VSS of a supply voltage source. An operational amplifier OP includes an inverting input terminal coupled to a node between the resistor R1 and the emitter of the transistor T1, a non-inverting input terminal coupled to a node between the resistors R2 and R3, and an output terminal coupled to gates of the transistors M1 and M2. A node between the resistor R2 and the drain of the transistor M2 is coupled to an output terminal VREF.

The voltage of the output terminal VREF can be obtained as follows by using emitter currents IE1 and 1E2 of the transistors T1 and T2.

−VREF=VBE1+R2/R3×(τT/q)×Ln (IE1/IE2) (12)

Note that VBE1 denotes a base-emitter voltage of the transistor T1.

Since the reference potential GND is used as a reference, the output voltage VREF has negative polarity. In the above expression (12), the first term has a negative temperature coefficient, and the second term has a positive temperature coefficient. Obviously, the voltage of the second term depends on a resistance ratio R2/R3 and a current ratio IE1/IE2. Therefore, the temperature coefficients are compensated by changing the current ratio IE1/IE2.

In the configuration of FIG. 8, a current regulator for regulating the current ratio IE1/IE2 is provided in parallel with the transistor M1. Transistors M3-M8 compose current sources. Transistors M9-M12 compose transistor switches, and on/off is controlled by potential of control input terminals SE1-SE4. The current regulator can increase or reduce the current IE1, thereby regulating the current ratio IE1/IE2 and compensating the temperature coefficients.

### SUMMARY

In the circuit configuration of FIG. 8, the emitter currents of the bipolar transistors are regulated to enable control for compensation of the temperature coefficients. However, the emitter currents of the bipolar transistors flow via the resistors. Accordingly, regulating the emitter currents increases or reduces voltages occurring at the resistors, which limits the regulation range of the emitter currents. As a result, the contorl range of a temperature gradient is limited.

It is an objective of the present disclosure to provide a configuration more freely controlling temperature characteristics in a reference-voltage generation circuit using a diode.

An aspect of the present disclosure provides a reference-voltage generation circuit including a first diode and a second diode, each including a cathode coupled to a first power supply; a first resistive element coupled between an anode of the first diode and an output node; a second resistive element and a third resistive element coupled in series between an anode of the second diode and the output node; an operational amplifier circuit configured to receive as an input, a node voltage between the anode of the first diode and the first resistive element, and a node voltage between the second and third resistive elements; a constant current control circuit including at least a transistor provided between a second power supply and the output node, configured to receive an output voltage of the operational amplifier circuit, and configured to supply a current to the first and second diodes via the transistor; and a regulating current supply section configured to receive the output voltage of the operational amplifier circuit, and supply a regulating current for regulating a diode current to the anode of one of the first or second diode. The regulating current supply section is capable of changing a magnitude of the regulating current, and is capable of generating a current proportionate to a diode current of the other one of the first or second diode as the regulating current.

According to this aspect, in the reference-voltage generation circuit using the diode, the regulating current supply section supplying the regulating current for regulating the diode current is provided in the anode of one of the first or second diode. The regulating current supply section can change the magnitude of the regulating current, and can generate the current proportionate to the diode current of the other one of the first and second diodes as the regulating current. Thus, even after manufacture of the circuit, the diode current can be directly regulated by changing the magnitude of the regulating current, and temperature characteristics of the reference-voltage generation circuit can be freely controlled by making the regulating current proportionate to the diode current of the other diode. In addition, since the regulating current does not flow through any resistive element and directly increases and reduces the diode current, the extent of regulating the current is not limited by a voltage. As a result, a wide control range of a temperature gradient can be provided.

According to the present disclosure, temperature characteristics of a reference-voltage generation circuit can be freely controlled, and a wide control range of a temperature gradient can be provided even after manufacture of the circuit.

### BRIEF DESCRIPTION OF THE DRAWINGS

FIG. 1 is a circuit diagram illustrating a configuration of a reference-voltage generation circuit according to a first embodiment.

FIG. 2 is a circuit diagram illustrating a configuration of a reference-voltage generation circuit including a current increasing circuit as an example of a regulating current supply section.

FIG. 3 is a circuit diagram illustrating a configuration of a reference-voltage generation circuit including a current reducing circuit as an example of the regulating current supply section.

FIG. 4 is a circuit diagram illustrating a configuration of a reference-voltage generation circuit according to a second embodiment.

FIG. 5 is a circuit diagram illustrating a configuration of a reference-voltage generation circuit according to a third embodiment.

FIG. 6 is a circuit diagram illustrating a configuration of a reference-voltage generation circuit according to a fourth embodiment.

FIG. 7 is a circuit diagram of a conventional reference-voltage generation circuit.

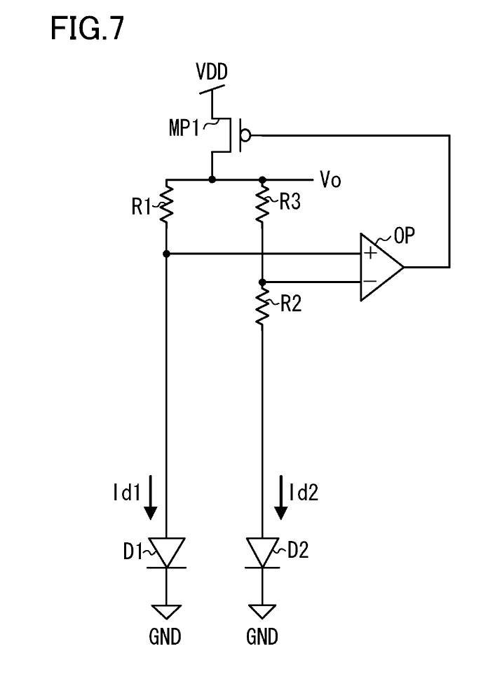

FIG. 8 is a circuit diagram of a conventional reference-voltage generation circuit.

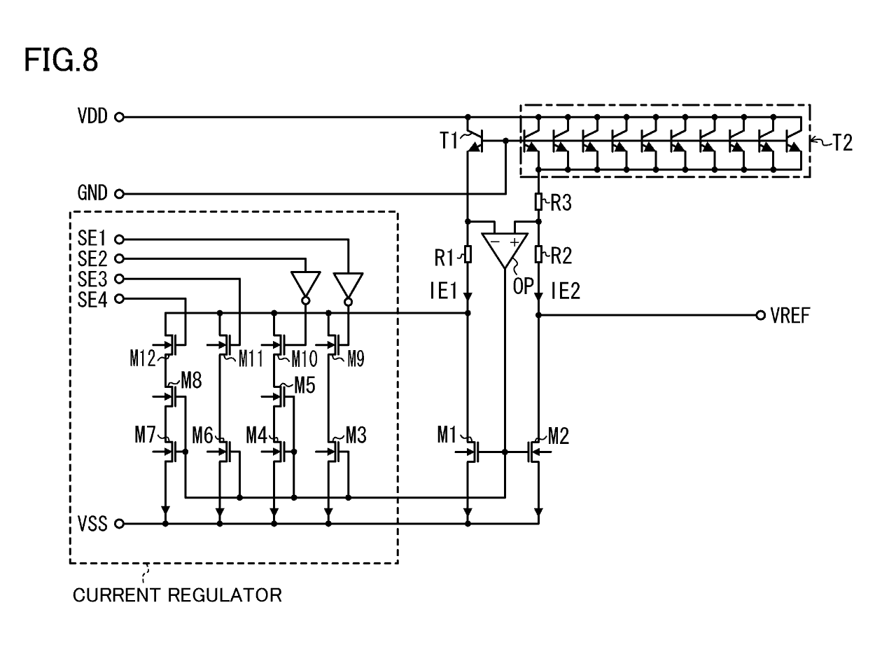

### DETAILED DESCRIPTION

Embodiments of the present disclosure will be described hereinafter with reference to the drawings.

### FIRST EMBODIMENT

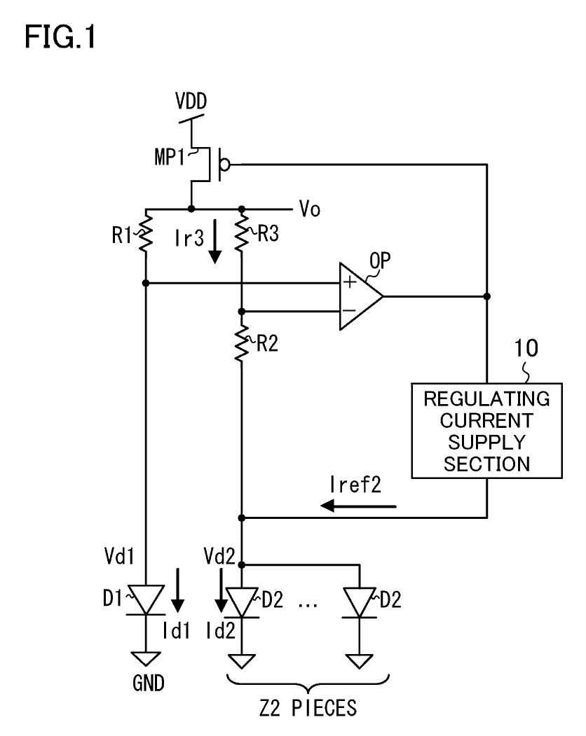

FIG. 1 is a circuit diagram illustrating a configuration of a reference-voltage generation circuit according to a first embodiment. The reference-voltage generation circuit shown in FIG. 1 directly regulates a diode current Id2, thereby changing temperature characteristics.

In FIG. 1, D1 denotes a first diode, and D2 denotes a second diode. Note that Z2 pieces of the second diode D2 are virtually provided in parallel. Each of the first and second diodes D1 and D2 includes a cathode coupled to a first power supply supplying ground potential GND. A first resistive element R1 is coupled between an anode of the first diode D1 and the output node Vo. A second resistive element R2 and a third resistive element and R3 are coupled in series between the anode of the second diode D2 and the output node Vo.

The operational amplifier circuit OP receives as an input, a node voltage between the anode of the first diode D1 and the first resistive element R1, and a node voltage between the second and third resistive elements R2 and R3. A PMOS transistor MP1 is provided between the output node Vo and a second power supply supplying positive power supply potential VDD. An output voltage of the operational amplifier circuit OP is applied to a gate of the PMOS transistor MP1. The PMOS transistor MP1 forms a constant current control circuit supplying currents to the first and second diodes D1 and D2.

A regulating current supply section 10 is provided, which supplies a regulating current Iref2 for regulating the diode current Id2 to the anode of the second diode D2. The regulating current supply section 10 receives the output voltage of the operational amplifier circuit OP, can generate a current proportionate to a diode current Id1 of the first diode D1, and supplies the current as the regulating current Iref2. This regulating current supply section 10 directly regulates the diode current Id2. Also, the regulating current supply section 10 can change the magnitude of the regulating current Iref2.

Regulation of the diode current Id2 in this embodiment will be described using numerical expressions.

In this embodiment, the expressions [1]-[5] of the known reference-voltage generation circuit described in the background of the disclosure are valid. In addition, the following expression [6] can be obtained.

Z2×Id2=Ir3+Iref2 [6]

Therefore, the output voltage Vo of the reference-voltage generation circuit is as follows.

Vo=Vd1+(R3/R2)×Vτ×Ln[Z2/{(R1/R3)+(Iref2/Id1)}]

Where

Iref2=A×Id1, (1)

Vo=Vd1+(R3/R2)×Vτ×Ln[Z2/{(R1/R3)+A}] (2)

is obtained.

That is, as shown in the expression (1), the regulating current Iref2 for regulating the diode current Id2 is made proportionate to the diode current Id1, thereby determining the second term having a positive temperature coefficient of the output voltage Vo in the expression (2) by a proportionality constant A. Therefore, temperature characteristics can be freely controlled by changing the proportionality constant A.

Next, a specific example configuration of the regulating current supply section will be described.

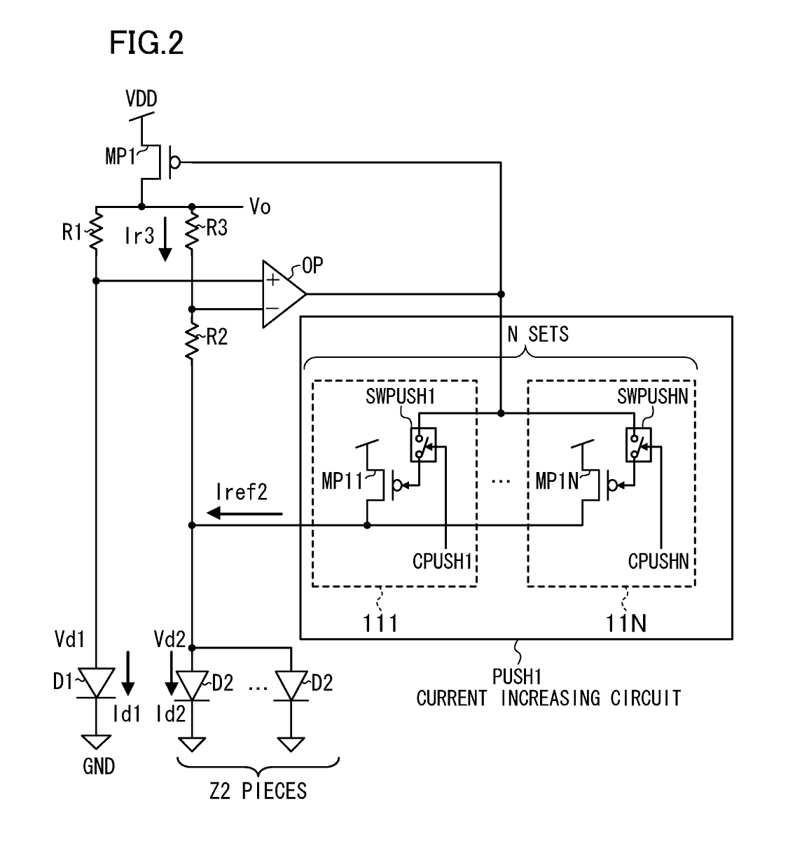

FIG. 2 is a circuit diagram illustrating a configuration of a reference-voltage generation circuit including a current increasing circuit PUSH1 as an example of the regulating current supply section. The current increasing circuit PUSH1 shown in FIG. 2 is for increasing the diode current Id2, and includes N reference current generation circuits 111-11N, where N is an integer of 1 or more. The reference current generation circuit 111 includes a PMOS transistor MP11, which includes a source coupled to the second power supply and a drain coupled to the anode of the second diode D2, and a switch SWPUSH1, which is a MOS transistor switchable whether or not to apply the output voltage of the operational amplifier circuit OP to a gate of the PMOS transistor MP11. The other reference current generation circuits have similar configurations. Switching control of the switches SWPUSH1-SWPUSHN by control signals CPUSH1-CPUSHN can change the magnitude of the regulating current Iref2.

The ratio of a current flowing to the first resistive element R1 to a current flowing to the third resistive element R3 is always constant, since a differential input of the operational amplifier circuit OP is virtually coupled to ground. That is, the ratio of R1/(R1+R3) of a current flowing from the PMOS transistor MP1 corresponds to the diode current Id1. In order to validate the expression (2), a current source of the current increasing circuit PUSH1 may be selected so that the ratio of the regulating current Iref2 to a current flowing from the PMOS transistor MP1 is A×R1/(R1+R3). The selection is implemented by the switches SWPUSH1-SWPUSHN. At this time, the constant A may be an integer or a decimal number.

Conditions for a change in the temperature coefficient where the diode current Id2 is regulated is considered. For example, the constant A for obtaining zero temperature coefficient which is independent from a temperature is considered. First, from the expression (2),

∂Vo/∂VT=∂Vd1/∂VT+(R3/R2)×κ/q×Ln[Z2/{(R1/R3)+A}]

is obtained. Where

∂Vo/∂VT=0,

since in the case of a room temperature, ∂Vd1/∂VT=1.5 mV/° K., κ/q=0.087 mV/° K.,

(R3/R2)×Ln[Z2/{(R1/R3)+A}]=17.2

is obtained. Where

R1:R2:R3=6:1:6,

Z2=36, and

A=1, the reference voltage Vo is independent from a temperature, and is 1.25 V. Note that, since A exists in the denominator, a negative temperature coefficient increases where A>1, and a positive temperature coefficient increases where A<1.

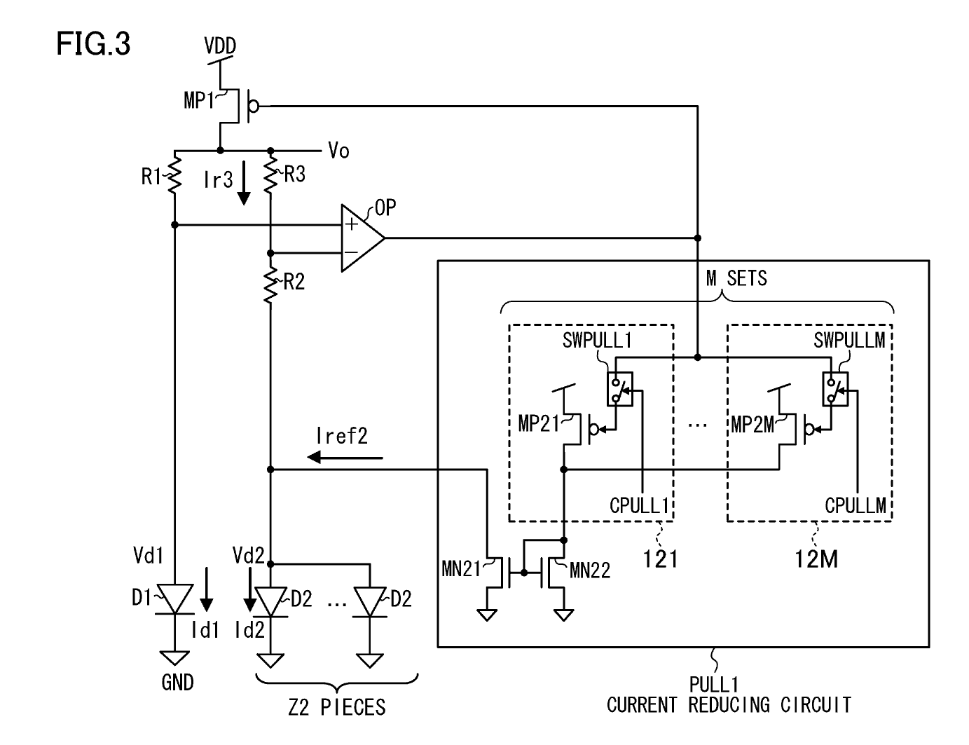

FIG. 3 is a circuit diagram illustrating a configuration of a reference-voltage generation circuit including a current reducing circuit PULL1 as an example of the regulating current supply section. The current reducing circuit PULL1 shown in FIG. 3 is for reducing the diode current Id2. The current reducing circuit PULL1 includes an NMOS transistor MN21 including a source coupled to the first power supply and a drain coupled to the anode of the second diode D2, an NMOS transistor MN22 including a source coupled to the first power supply and a drain and a gate coupled to a gate of the NMOS transistor MN21, and M reference current generation circuits 121-12M, where M is an integer of 1 or more. The NMOS transistor MN21 mirrors a current flowing to the NMOS transistor MN22. The reference current generation circuit 121 includes a PMOS transistor MP21, which includes a source coupled to the second power supply and a drain coupled to the drain of the NMOS transistor MN22, and a switch SWPULL1, which is a MOS transistor switchable whether or not to apply the output voltage of the operational amplifier circuit OP to a gate of the PMOS transistor MP21. The other reference current generation circuits have similar configurations. Switching control of switches SWPULL1-SWPULLM by control signals CPULL1-CPULLM changes the magnitude of the regulating current Iref2.

Setting of a regulating current is similar to that in the first embodiment and explanation thereof is omitted. Note that, by setting such a current reducing circuit PULL1, part of the diode current flows to an NMOS transistor of the current reducing circuit PULL1. This reduces the number of diodes, and a secondary advantage of reducing the area of a chip can be provided.

Note that the output voltage of the operational amplifier circuit OP is applied to gates of the PMOS transistors MP11-MP1N in the current increasing circuit PUSH1 shown in FIG. 2, and gates of the PMOS transistors MP21-MP2M in the current reducing circuit PULL1 shown in FIG. 3, similar to the gate of the PMOS transistor MP1 which forms a constant current control circuit. That is, the gate potential of the PMOS transistors MP11-MP1N, MP21-MP2M is equal to the gate potential of the PMOS transistor MP1. Thus, a current proportionate to the diode current Id1 is generated as the regulating current Iref2.

As such, according to this embodiment, the regulating current supply section 10 is provided, which supplies the regulating current Iref2 for regulating the diode current Id2 to the anode of the second diode D2. This regulating current supply section 10 can change the magnitude of the regulating current Iref2, and can generate a current proportionate to the diode current Id1 of the first diode D1 as the regulating current Iref2. Thus, the diode current Id2 can be directly regulated, and the temperature characteristics of the reference-voltage generation circuit can be freely controlled even after manufacture of the circuit. In addition, since the regulating current Iref2 does not flow through any resistive element, and directly increases and reduces the diode current Id2, the extent of regulating the current is not limited by a voltage. As a result, a wide control range of a temperature gradient can be provided.

Note that the current increasing circuit PUSH1 shown in FIG. 2, and the current reducing circuit PULL1 shown in FIG. 3 are merely example circuit configurations, and other circuit configurations may be used, which have a similar function of increasing and reducing a current.

The regulating current supply section 10 may include both of the current increasing circuit PUSH1 shown in FIG. 2 and the current reducing circuit PULL1 shown in FIG. 3. This configuration provides a wide regulation range of the current ratio of the diode current Id1 to the diode current Id2.

### SECOND EMBODIMENT

In the first embodiment, the diode current Id2 is directly regulated by the regulating current Iref2 using the diode current Id1 as a reference. By contrast, in this embodiment, the diode current Id1 is directly regulated by the regulating current Iref1 using the diode current Id2 as a reference.

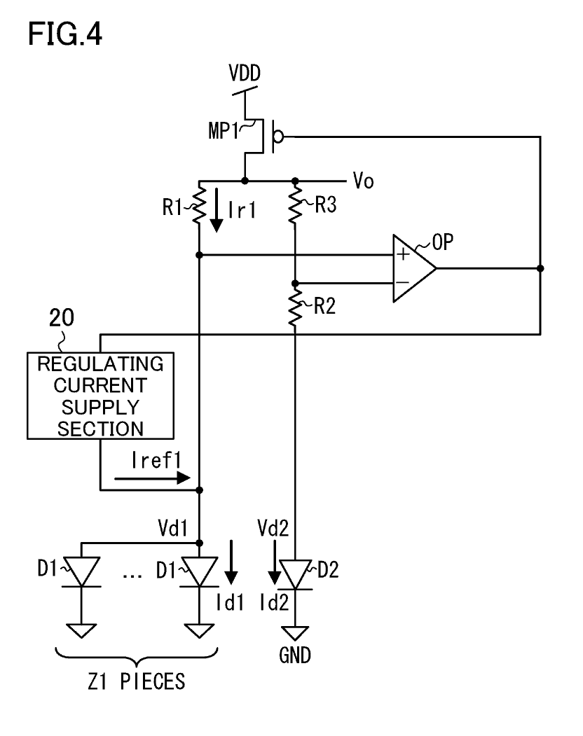

FIG. 4 is a circuit diagram illustrating a configuration of a reference-voltage generation circuit according to the second embodiment. The reference-voltage generation circuit shown in FIG. 4 can change temperature characteristics by directly regulating the diode current Id1. In FIG. 4, the same reference characters as those shown in FIG. 1 are used to represent equivalent elements, and the detailed explanation thereof will be omitted. Note that Z1 pieces of the first diode D1 are virtually provided in parallel.

A regulating current supply section 20 is provided, which supplies a regulating current Iref1 for regulating the diode current Id1 to the anode of the first diode D1. The regulating current supply section 20 receives the output voltage of the operational amplifier circuit OP, can generate a current proportionate to the diode current Id2 of the second diode D2, and supply this current as the regulating current Iref1. This regulating current supply section 20 directly regulates the diode current Id1. Also, the regulating current supply section 20 can change the magnitude of the regulating current Iref1.

Regulation of the diode current Idl in this embodiment will be described using numerical expressions.

In this embodiment, the following expressions [7]-[10] can be obtained in addition to the expressions [1] and [2] of the known reference-voltage generation circuit described in the background of the disclosure.

Ir1=(Vo−Vd1)/R1 [7]

Id2=(Vd1−Vd2)/R2 [8]

Id2=(Vo−Vd1)/R3 [9]

Z1×Id1=Ir1+Iref1 [10]

Therefore, the output voltage Vo of the reference-voltage generation circuit is as follows.

Vo=Vd1+(R3/R2)×Vτ×Ln[{(R3/R1)+(Iref1/Id2)}/Z1]

Where Iref1=a×Id2 (3)

Vo=Vd1+(R3/R2)×Vτ×Ln[{(R3/R1)+a}/Z1] (4)

is obtained.

That is, as shown in the expression (3), the regulating current Iref1 for regulating the diode current Id1 is made proportionate to the diode current Id2, thereby determining the second term having a positive temperature coefficient of the output voltage Vo in the expression (2) by a proportionality constant ‘a’. Therefore, the temperature coefficient can be freely controlled by changing the proportionality constant ‘a’.

A specific example configuration of the regulating current supply section 20 is similar to that in the first embodiment. For example, the current increasing circuit PUSH1 shown in FIG. 2 and the current reducing circuit PULL1 shown in FIG. 3 may be provided.

The ratio of R3/(R1+R3) of a current flowing from the PMOS transistor MP1 corresponds to the diode current Id2. Thus, when the current increasing circuit PUSH1 shown in FIG. 2 is provided, a current source of the current increasing circuit PUSH1 may be selected so that the ratio of the regulating current Iref1 to a current flowing from the PMOS transistor MP1 is ‘a’×R3/(R1+R3) to validate the expression (4). The selection is implemented by the switches SWPUSH1-SWPUSHN. At this time, the constant ‘a’ may be an integer or a decimal number. This is also applicable to the case where the current reducing circuit PULL1 shown in FIG. 3 is provided.

Conditions for a change in the temperature coefficient where the diode current Id1 is regulated is here considered. Based on the calculation of the condition expression of the constant A shown in the first embodiment, and where the number of diodes Z1=1 and ‘a’=17, the reference voltage Vo is independent from a temperature, and is 1.25 V. Note that, since ‘a’ exits in the numerator, a positive temperature coefficient increases where ‘a’>17, and a negative temperature coefficient increases where ‘a’>17.

In this embodiment, an advantage similar to that of the first embodiment can be obtained. Specifically, the regulating current supply section 20 is provided, which supplies the regulating current Iref1 for regulating the diode current Id1 to the anode of the first diode D1. The regulating current supply section 20 can change the magnitude of the regulating current Iref1, and can generate a current proportionate to the diode current Id2 of the second diode D2 as the regulating current Iref1. Thus, the diode current Id1 can be directly regulated, and the temperature characteristics of the reference-voltage generation circuit can be freely controlled even after manufacture of the circuit. In addition, since the regulating current Iref1 does not flow through any resistive element and directly increases and reduces the diode current Id1, a voltage due to the regulating current Irefl does not occur and the extent of regulating the current is not limited. As a result, a wide control range of a temperature gradient can be provided. In contrast, in case where the regulating current Iref1 flows through a resistive element for controlling the diode current Id1, a voltage occurs at the resistive element and the extent of regulating the current is limited by the voltage.

Note that the regulating current supply section 20 may include both of the current increasing circuit PUSH1 shown in FIG. 2 and the current reducing circuit PULL1 shown in FIG. 3. This configuration provides a wide regulation range of the current ratio of the diode current Id1 to the diode current Id2.

### THIRD EMBODIMENT

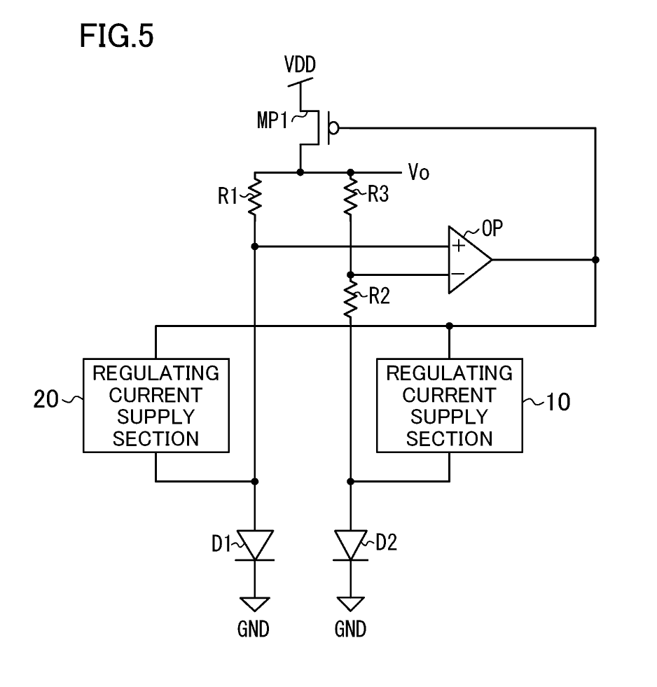

FIG. 5 illustrates a configuration of a reference-voltage generation circuit according to a third embodiment. The reference-voltage generation circuit shown in FIG. 5 includes both of the regulating current supply section 10 shown in the first embodiment, and the regulating current supply section 20 shown in the second embodiment.

Specific example configurations of the regulating current supply sections 10 and 20 are as described above, and the explanation thereof is omitted. Note that, for example, each of the regulating current supply sections 10 and 20 may include a current increasing circuit, a current reducing circuit, or both of a current increasing circuit and a current reducing circuit. One of the regulating current supply section 10 or 20 may include a current increasing circuit, and the other may include a current reducing circuit. Alternately, one of the regulating current supply section 10 or 20 may include both of a current increasing circuit and a current reducing circuit, and the other may include one of a current increasing circuit or a current reducing circuit.

### FOURTH EMBODIMENT

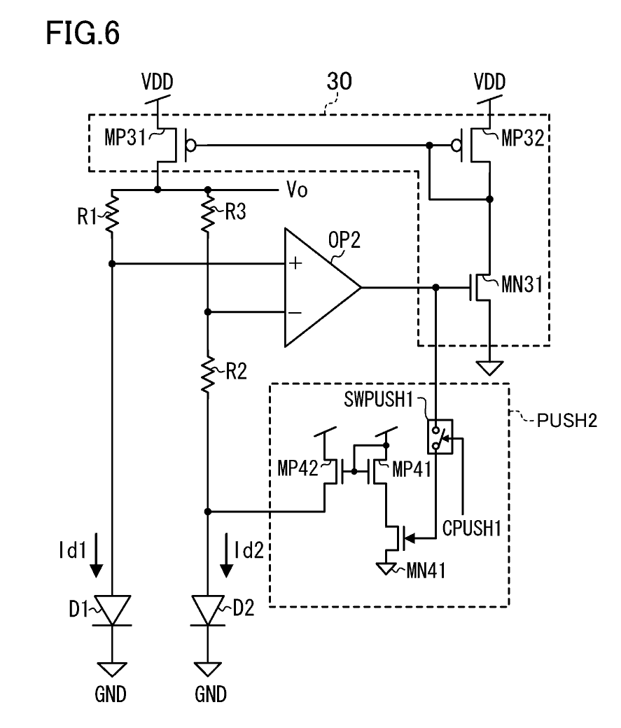

FIG. 6 illustrates a configuration of a reference-voltage generation circuit according to a fourth embodiment. In the configuration of FIG. 1, the constant current control circuit includes the PMOS transistor MP1 provided between the output node Vo and the second power supply supplying the positive power supply potential VDD. On the other hand, the configuration of FIG. 6 includes a constant current control circuit 30 different from the configuration of FIG. 1. The constant current control circuit 30 includes a PMOS transistor MP31 including a source coupled to the second power supply and a drain coupled to the output node Vo, a PMOS transistor MP32 including a source coupled to the second power supply, and a drain and a gate coupled to a gate of the PMOS transistor MP31, and an NMOS transistor MN31 including a source coupled to the first power supply, a drain coupled to the drain of the PMOS transistor MP32, and a gate receiving an output voltage of the operational amplifier circuit OP2. The operational amplifier circuit OP2 has the internal configuration, in which the current mirror section, which corresponds to the transistors MP32 and MN 31, is omitted from the operational amplifier circuit OP shown in FIG. 1.

FIG. 6 illustrates a current increasing circuit PUSH2 as an example of the regulating current supply section. The current increasing circuit PUSH2 includes a PMOS transistor MP42 including a source coupled to the second power supply and a drain coupled to the anode of the second diode D2, a PMOS transistor MP41 including a source coupled to the second power supply and a drain and a gate coupled to a gate of the PMOS transistor MP42, an NMOS transistor MN41 including and a source coupled to the first power supply and a drain coupled to the drain of the PMOS transistor MP41, and a switch SWPUSH1 switchable whether or not to apply an output voltage of an operational amplifier circuit OP2 to the gate of the NMOS transistor MN41. Switching of the switch SWPUSH1 is controlled by a control signal CPUSH1.

In this embodiment as well, the advantage similar to those of the above-described embodiments is obtained.

In the circuit configurations of the above-described embodiments, an example has been described where the first power supply supplies the ground potential GND, and the second power supply supplies the positive power supply potential VDD. However, for example, a reference-voltage generation circuit having the configuration including a first power supply supplying negative power-supply potential VSS, and a second power supply supplying the ground potential GND may be feasible, similar to the embodiments. In this case, for example, in the configuration of FIG. 1, the PMOS transistor MP1 is replaced with an NMOS transistor.

In the above-described embodiments, each of the first and second diodes D1 and D2 may be formed of a single diode element, or a plurality of diode elements coupled in series or parallel.

In the present disclosure, the temperature characteristics of the reference-voltage generation circuit can be changed easily and freely. Therefore, the present disclosure is useful, for example, as a reference-voltage generation circuit particularly utilizing temperature characteristics.

What is claimed is:

1. A reference-voltage generation circuit comprising:
a first diode and a second diode, each including a cathode coupled to a first power supply;
a first resistive element coupled between an anode of the first diode and an output node;
a second resistive element and a third resistive element coupled in series between an anode of the second diode and the output node;
an operational amplifier circuit configured to receive as an input, a node voltage between the anode of the first diode and the first resistive element, and a node voltage between the second and third resistive elements;
a constant current control circuit including at least a transistor provided between a second power supply and the output node, configured to receive an output voltage of the operational amplifier circuit, and configured to supply a current to the first and second diodes via the transistor; and
a regulating current supply section configured to receive the output voltage of the operational amplifier circuit, and supply a regulating current for regulating a diode current to the anode of one of the first or second diode, wherein
the regulating current supply section is capable of changing a magnitude of the regulating current, and capable of generating a current proportionate to a diode current of the other one of the first or second diode as the regulating current.

2. The reference-voltage generation circuit of claim 1, wherein
the constant current control circuit includes as the transistor, a PMOS transistor including a source coupled to the second power supply, and a drain coupled to the output node, and a gate receiving the output voltage of the operational amplifier circuit.

3. The reference-voltage generation circuit of claim 2, wherein
the regulating current supply section includes a current increasing circuit configured to increase a diode current,
the current increasing circuit includes at least one reference current generation circuit, and
the reference current generation circuit includes
a second PMOS transistor including a source coupled to the second power supply, and a drain coupled to the anode of the one of the diodes, and
a switch configured to switch whether or not to apply the output voltage of the operational amplifier circuit to a gate of the second PMOS transistor.

4. The reference-voltage generation circuit of claim 2, wherein
the regulating current supply section includes a current reducing circuit configured to reduce a diode current,
the current reducing circuit includes
at least one reference current generation circuit,
a first NMOS transistor including a source coupled to the first power supply, and a drain coupled to the anode of the one of the diodes, and
a second NMOS transistor including a source coupled to the first power supply, and a drain and a gate coupled to a gate of the first NMOS transistor, and
the reference current generation circuit includes
a second PMOS transistor including a source coupled to the second power supply, and a drain coupled to the drain of the second NMOS transistor, and
a switch configured to switch whether or not to apply the output voltage of the operational amplifier circuit to a gate of the second PMOS transistor.

5. The reference-voltage generation circuit of claim 1, wherein
the constant current control circuit includes
a first PMOS transistor including a source coupled to the second power supply, and a drain coupled to the output node,
a second PMOS transistor including a source coupled to the second power supply, and a drain and a gate coupled to a gate of the first PMOS transistor, and
an NMOS transistor including a source coupled to the first power supply, a drain coupled to the drain of the second PMOS transistor, and a gate receiving the output voltage of the operational amplifier circuit.

6. The reference-voltage generation circuit of claim 1, further comprising
a second regulating current supply section configured to receive the output voltage of the operational amplifier circuit, and supply a second regulating current for regulating a diode current to the anode of the other diode, wherein
the second regulating current supply section is capable of changing a magnitude of the second regulating current, and is capable of generating a current proportionate to a diode current of the one of the diodes as the second regulating current.

7. The reference-voltage generation circuit of claim 1, wherein
the first power supply supplies ground potential, and
the second power supply supplies positive power supply potential.

8. The reference-voltage generation circuit of claim 3, wherein
the regulating current supply section includes a current reducing circuit configured to reduce a diode current,
the current reducing circuit includes
at least one reference current generation circuit,
a first NMOS transistor including a source coupled to the first power supply, and a drain coupled to an anode of the one of the diodes, and
a second NMOS transistor including a source coupled to the first power supply, and a drain and a gate coupled to a gate of the first NMOS transistor, and
the reference current generation circuit includes
a third PMOS transistor including a source coupled to the second power supply, and a drain coupled to the drain of the second NMOS transistor, and
a second switch switchable whether or not to apply the output voltage of the operational amplifier circuit to a gate of the third PMOS transistor.
